(19) United States
(12) Patent Application Publication
(10) Pub. No.: US 2006/0232381 A1
(43) Pub. Date: Oct. 19, 2006

(54) Multiple enclosure security storage apparatus and method for securely storing valuable items

(76) Inventor: Peter K. Gauthier, Burlington (CA)

Correspondence Address: HOFBAUER ASSOCIATES, SUITE 205 NORTH, 1455 LAKESHORE ROAD, BURLINGTON, ON, L7S 2J1, CA

(21) Appl. No.: 11/105,471

(22) Filed: Apr. 14, 2005

(51) Int. Cl. H04B 1/00; G05B 19/00

(52) U.S. Cl. 340/5.73; 70/85

(57) ABSTRACT

A multiple enclosure security storage apparatus for storing valuable items, including a housing, enclosures, a locking apparatus associated the enclosures, and an unlocking control system connected to the locking apparatus. Each enclosure defines a storage compartment adapted to store valuable items, and is movable between closed and open configurations. In the closed configuration, access to the storage compartment is obstructed. In the open configuration, the storage compartment is accessible. The locking apparatus moves each enclosure between locked and unlocked configurations. In the locked configuration, the enclosure is secured in the closed configuration. In the unlocked configuration, the enclosure is movable between the closed and open configurations. The unlocking control system disables unlocking of the enclosures when any one enclosure is in the unlocked configuration, and enables a selected enclosure to be unlocked only when all of the enclosures are in the locked configuration.

### FIELD OF THE INVENTION

The present invention relates to the field of security storage devices and, more particularly, to a multiple enclosure security storage apparatus and method for securely storing valuable items.

### BACKGROUND OF THE INVENTION

Pawn shops and banks—as depositories for valuable items—are faced with the constant threat of armed robbery. To date, safes and other locked enclosures have been only somewhat useful in storing valuable items on the premises, and it is becoming more and more common for armed assailants to use intimidation and threat of violence to forcefully persuade bank tellers and pawn shop attendants to quickly open such locked enclosures using their access code or key at hand. It should be appreciated, therefore, that violent thieves wielding weapons have thus far met with insufficient resistance to prevent them from quickly and efficiently emptying the safes and locked enclosures in pawn shops, banks and other depositories of valuable items.

Today, most pawn shops and banks have alarm systems which automatically alert security or police forces in the event of a robbery. While the authorities are constantly trying to reduce their response times, there can still sometimes be a significant delay before these personnel arrive at the premises of the robbery—a delay which often allows thieves to escape with valuable items or one which might otherwise be a harrowing or life-threatening experience for the store attendant or teller. What is needed, therefore, is a device and method for storing valuable items that serves as a disincentive to armed robbery and significantly delays a thief in emptying the valuable contents from a pawn shop or bank vault, so as to permit the arrival of security and police forces to apprehend the criminal.

In the prior art, such as for example in U.S. Pat. No. 2,113,966 (Schneider), it has been known to provide a door locking mechanism that only unlocks an enclosure after a predetermined desired time delay has elapsed. One of the serious problems associated with the Schneider: device, however, is that it does not include any mechanism to keep more than one enclosure from being opened at the same time. That is, a thief could easily initiate the unlocking of a second enclosure immediately after the first one, a third after the second, and so on (i.e., without being forced to wait for any time delay to elapse), such that the thief might thereby make efficient use of his time and ensure that the first unlocked enclosure was opened by the time he had begun unlocking the last of the enclosures.

Other prior art safety deposit box systems, such as that disclosed in U.S. Pat. No. 5,475,376 (Chikamitue et al.), are designed to be installed within existing vaults and to prohibit the exit of users until all of the safety deposit boxes have been closed. While such systems are capable of assessing whether each box has been closed, this assessment only prevents exit from the vault. As with the Schneiders device, therefore, the Chikamitue system suffers from a serious problem, at least insofar as it allows robbers to efficiently open all of the safety deposit boxes, one after another, to empty the boxes of their valuable contents, and then close all of the boxes and exit the vault.

Accordingly, pawn shops and banks using either the Schneiders device or the Chikamitue system are still subject to the same risk of robbery, and they can allow thieves to get away with a large number of valuable items in a relatively short period of time (i.e., without slowing them down enough to enable the authorities to attend on site).

What is needed, therefore, is a security storage apparatus and method for securely storing valuable items that requires a user to ensure that all of the compartments are locked before enabling the user to open any one of them. Such a system, especially if also equipped with a time delay means, would preferably significantly delay an armed robbery attempt. In so doing, the system would preferably facilitate the timely attendance of security and police authorities on site, and thereby reduce the possibility that a thief might escape after emptying a pawn shop or bank of valuable contents.

It is, therefore, one object of the present invention to provide a multiple enclosure security storage apparatus for storing valuable items.

It is an object of a further aspect of the present invention to provide a multiple enclosure security storage apparatus which helps to delay armed robbery attempts.

It is an object of another aspect of the present invention to provide a multiple enclosure security storage apparatus which is adapted to disable the unlocking of all of its enclosures when any one of the enclosures is in an unlocked configuration.

It is an object of still another aspect of the present invention to provide a multiple enclosure security storage apparatus which only enables unlocking of a selected one of its enclosures when all of them are in a locked configuration.

It is an object of a yet further aspect of the present invention to provide a multiple enclosure security storage apparatus which is adapted to determine when any one of its enclosures is in an unlocked configuration.

It is an object of yet another aspect of the present invention to provide a multiple enclosure security storage apparatus which reduces the number of armed robbery attempts made upon businesses utilizing same.

It is an object of yet another aspect of the present invention to provide a multiple enclosure security storage apparatus that is suitable for use in pawn shops.

It is an object of a yet still further aspect of the present invention to provide a multiple enclosure security storage apparatus that is adapted to delay the unlocking of its enclosures by a predetermined time interval.

It is an object of a further aspect of the present invention to provide a multiple enclosure security storage apparatus which enables an authorized user to manually set a time delay for unlocking its enclosures.

It is an object of a still yet further aspect of the present invention to provide a multiple enclosure security storage apparatus which enables an authorized user to selectively bypass the time delay for unlocking its enclosures.

It is an object of a further aspect of the present invention to provide a multiple enclosure security storage apparatus which maintains its enclosures in a locked configuration in the event of a power failure or interruption.

It is an object of a further aspect of the present invention to provide a multiple enclosure security storage apparatus that requires entry of an authorized user identification datum before enabling the unlocking of its enclosures.

It is an object of yet another aspect of the present invention to provide a multiple enclosure security storage apparatus which enables an authorized user to select different levels of access for different users, enclosures, and times of day.

It is an object of a yet still further aspect of one aspect of the present invention to provide a multiple enclosure security storage apparatus which is adapted to record event data when an authorized user unlocks an enclosure, manually sets a time delay, bypasses a time delay, or changes user permissions.

It is an object of another aspect of the present invention to provide a multiple enclosure security storage apparatus which is adapted to record user identification data, time signature data and enclosure identification data.

It is an object of a further aspect of the present invention to provide a multiple enclosure security storage apparatus which is intended to be installed within an existing safe.

It is an object of yet still another aspect of the present invention to provide a multiple enclosure security storage apparatus that minimally delays an authorized user during its normal operation.

### SUMMARY OF THE INVENTION

In accordance with the present invention there is disclosed a multiple enclosure security storage apparatus for storing valuable items. The apparatus includes a housing having a plurality of enclosures, an electrically actuable locking apparatus associated with each of the enclosures, and an unlocking control system operably connected to the locking apparatus. Each enclosure of the plurality defines an interior storage compartment that is adapted to store valuable items. Each enclosure is movable between a closed configuration and an open configuration. In the closed configuration, access to the storage compartment is substantially obstructed. In the open configuration, the storage compartment is substantially readily accessible. The locking apparatus is adapted to selectively move the enclosure between a locked configuration and an unlocked configuration. In the locked configuration, the enclosure is substantially securely maintained in the closed configuration. In the unlocked configuration, the enclosure is substantially readily movable between the closed configuration and the open configuration. The unlocking control system is adapted to disable movement of all of the enclosures from the locked configuration towards the unlocked configuration when at least one enclosure is in the unlocked configuration. The unlocking control system is further adapted to enable selective movement of a selected one enclosure from the locked configuration towards the unlocked configuration when all of the enclosures are in the locked configuration.

In accordance with a further aspect of the present invention, the unlocking control system is provided with an enclosure status subsystem that includes a plurality of status switches operably connected to one another. Each of the status switches is associated with a respective one of the enclosures and is adapted to determine when the respective one is in the unlocked configuration.

In accordance with a still further aspect of the present invention, in the locked configuration, the respective one of the enclosures engages a corresponding one of the status switches. In the unlocked configuration, the respective one of the enclosures is removed from the corresponding one of the status switches.

In accordance with a different aspect of the present invention, the locking apparatus includes locking subsystems operably connected to the unlocking control system. Each of the locking subsystems is associated with a respective one enclosure. Each of the locking subsystems includes an electrically actuable lock assembly having a latch member. In the locked configuration, the latch member securely engages the respective one enclosure. In the unlocked configuration, the latch member is disengaged from the enclosure.

In accordance with a further aspect of the present invention, the electrically actuable lock assembly also includes a solenoid operably connected to the unlocking control system and adapted to move the latch member between the locked configuration and the unlocked configuration.

In accordance with another aspect of the present invention, each of the plurality of enclosures is a drawer, and the housing is shaped so as to define a corresponding plurality of outward-facing drawer slots. Each drawer slot of the corresponding plurality defines a longitudinal axis and receives one drawer in longitudinally sliding relation therein. Each drawer defines a through-passing storage aperture into its respective storage compartment. In the closed configuration, the drawer is received within the drawer slot, such that the storage aperture is substantially obstructed. In the open configuration, the drawer is outwardly displaced from the closed configuration along the longitudinal axis, such that the storage aperture is substantially unobstructed, and such as to permit the aforesaid ready access into the storage compartment.

In accordance with a further aspect of the present invention, each of the drawer slots is defined by longitudinal slot walls of the housing. At least one of the slot walls has a longitudinal slot track member securely mounted thereto. Each drawer is provided with longitudinal drawer walls. At least one of the drawer walls has a longitudinal mating drawer track member securely mounted thereto. The slot track member engages the mating drawer track member in longitudinally sliding relation.

In accordance with a different aspect of the present invention, the unlocking control system is adapted to delay the aforesaid selective movement of the selected enclosure towards the unlocked configuration by a predetermined time interval.

In accordance with a further aspect of the present invention, the predetermined time interval may be preselected by a user of the apparatus.

In accordance with a still further aspect of the present invention, the unlocking control system is adapted to record event data when the predetermined time interval is preselected.

In accordance with a yet further aspect of the present invention, the unlocking control system includes a display means for displaying, within view of a user of the apparatus, an upward-counting elapsed time indicia over a substantial duration of the predetermined time interval.

In accordance with a still yet further aspect of the present invention, the unlocking control system includes a user input device. The user input device is adapted to selectively enable the aforesaid movement of the selected enclosure towards the unlocked configuration without an intervening passage of the predetermined time interval.

In accordance with a yet still further aspect of the present invention, the unlocking control system requires entry of an authorized bypass user identification datum before enabling movement towards the unlocked configuration without the intervening passage of the predetermined time interval.

In accordance with a further aspect of the present invention, the unlocking control system is adapted to record event data upon enabling movement towards the unlocked configuration without the intervening passage of the predetermined time interval.

In accordance with a different aspect of the present invention, the security storage apparatus also includes biasing means for biasing each enclosure towards the open configuration.

In accordance with another aspect of the present invention, the locked configuration is a default configuration, such that the locking apparatus maintains each enclosure in the locked configuration the event of a power interruption or failure.

In accordance with a different aspect of the present invention, the unlocking control system includes a user input device that is adapted to enable entry of a first authorized user identification datum. The unlocking control system is adapted to only enable the aforesaid selective movement towards the unlocked configuration after entry of the first authorized user identification datum.

In accordance with a further aspect of the present invention, upon entry of the first authorized user identification datum, the unlocking control system is further adapted to inhibit movement of a first predetermined subset of the plurality of enclosures towards the unlocked configuration. The first predetermined subset consists of at least one enclosure.

In accordance with a still further aspect of the present invention, the first predetermined subset is a user-preselected subset.

In accordance with a yet further aspect of the present invention, the unlocking control system is adapted to record event data when the user-preselected subset is preselected.

In accordance with a still yet further aspect of the present invention, the user input device is further adapted to enable entry of a second authorized user identification datum. Upon entry of the second authorized user identification datum, the unlocking control system is further adapted to inhibit movement of a second predetermined subset of the plurality of enclosures towards the unlocked configuration. The second predetermined subset consists of at least one enclosure.

In accordance with a yet still further aspect of the present invention, the second predetermined subset consists of at least one enclosure that is excluded from the first predetermined subset.

In accordance with another aspect of the present invention, the unlocking control system is adapted to record a user identification datum when the selected one enclosure is moved from the locked configuration towards the unlocked configuration.

In accordance with a different aspect of the present invention, the unlocking control system is further adapted to disable movement from the locked configuration towards the unlocked configuration at a predetermined time.

In accordance with another aspect of the present invention, the unlocking control system is adapted to record event data when each enclosure is moved from the locked configuration towards the unlocked configuration.

In accordance with a further aspect of the present invention, the event data includes an enclosure identification datum.

In accordance with a further aspect of the present invention, the event data includes a time signature datum.

In accordance with the present invention there is also disclosed an alternate multiple enclosure security storage apparatus for storing valuable items. The apparatus includes a housing having a plurality of enclosures. Each enclosure of the plurality defines an interior storage compartment that is adapted to store valuable items. Each enclosure is movable between a closed configuration and an open configuration. In the closed configuration, access to the storage compartment is substantially obstructed. In the open configuration, the storage compartment is substantially readily accessible. The apparatus also includes a locking means, associated with each enclosure, for selective movement of the enclosure between a locked configuration and an unlocked configuration. In the locked configuration, the enclosure is substantially securely maintained in the closed configuration. In the unlocked configuration, the enclosure is substantially readily movable between the closed configuration and the open configuration. The apparatus also includes an unlocking control means, operably connected to the locking means, for disabling movement of all of the enclosures from the locked configuration towards the unlocked configuration when at least one enclosure is in the unlocked configuration, and for enabling selective movement of a selected one enclosure from the locked configuration towards the unlocked configuration only when all of the enclosures are in the locked configuration.

In accordance with the present invention there is also disclosed a method for securely storing valuable items in a multiple enclosure security storage apparatus. Each enclosure of the apparatus is selectively electromechanically movable between a locked closed configuration and an unlocked configuration. The method includes an initial step of awaiting a user selection of a first enclosure to be electromechanically moved towards the unlocked configuration. The method includes a second step of electromechanically moving the first enclosure towards the unlocked configuration. The method then electromechanically determines whether the first enclosure has been returned to the locked closed configuration. If the first enclosure has not been returned to the locked closed configuration, the method electromechanically impedes movement of a second enclosure towards the unlocked configuration. If the first enclosure has been returned to the locked closed configuration, the method enables movement of the second enclosure towards the unlocked configuration.

In accordance with one aspect of the present invention, the method includes an additional step, after the initial step, of electronically delaying advancement to the second step by a predetermined time delay interval.

In accordance with a further aspect of the present invention, the method comprises a further additional step of displaying an upward-counting elapsed time indicia, within view of the user, for a substantial duration of the predetermined time delay interval.

In accordance with a different aspect of the present invention, the method includes an additional initial step of electronically delaying advancement to the initial step until the user enters a user identification datum for a first time.

In accordance with a further aspect of the present invention, the method includes an additional step of electronically delaying advancement to the second step until the user enters the user identification datum for a second time.

In accordance with a further aspect of the present invention, the method includes an additional step of electronically determining whether the user identification datum is a time delay bypass datum. If the user identification datum is not the time delay bypass datum, the method electronically delays advancement to the second step by a predetermined time delay interval. If the user identification datum is the time delay bypass datum, the method proceeds to the second step without an intervening passage of the aforesaid predetermined time delay interval.

In accordance with a further aspect of the present invention, the method includes an additional step of electronically determining whether entry of the user identification datum permits movement of the first enclosure towards the unlocked configuration. If the aforesaid entry of the user identification datum does not permit movement of the first enclosure towards the unlocked configuration, the method returns to the initial step. If the aforesaid entry of the user identification datum permits movement of the first enclosure towards the unlocked configuration, the method proceeds to the second step.

In accordance with a different aspect of the present invention, the method includes an additional step of electronically determining whether the first enclosure is permitted to move towards the unlocked configuration at the current time and date. If the first enclosure is not permitted to move towards the unlocked configuration at the current time and date, the method electronically delays advancement to the second step until a permitted time and date at which the first enclosure is permitted to move towards the unlocked configuration. If the first enclosure is permitted to move towards the unlocked configuration at the current time and date, the method proceeds to the second step.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the multiple enclosure security storage apparatus and method for securely storing valuable items according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a top front right perspective view of a security storage apparatus according to the invention, showing a drawer in the open configuration;

FIG. 2 is a top front right perspective view similar to FIG. 1, showing the drawer in the locked configuration;

FIG. 3 is a front elevational view on an enlarged scale of encircled area 3 of FIG. 2;

FIG. 4 is a front elevational view on an enlarged scale of encircled area 4 of FIG. 3;

FIG. 5 is a top front right perspective view similar to FIG. 1, showing a second drawer in the open configuration;

FIG. 6 is a top front right perspective view similar to FIG. 5, shown with the second drawer removed therefrom for ease of illustration;

FIG. 7 is a top rear left perspective view of the security storage apparatus of FIG. 1, showing a locking apparatus and an unlocking control system, and shown with rear and top panels removed therefrom for ease of illustration;

FIG. 8 is a top rear right perspective view on an enlarged scale of encircled area 8 of FIG. 7, showing a drawer in the locked configuration;

FIG. 9 is a rear top right perspective view of the drawer of FIG. 8, shown in the open configuration;

FIG. 10 is a top elevational view of the security storage apparatus of FIG. 8, showing U-bolt and latch members in phantom outline, and shown with a drawer status switch removed therefrom for ease of illustration;

FIG. 11 is a right elevational view of the security storage apparatus of FIG. 8, showing the U-bolt member in phantom outline;

FIG. 12 is a top elevational view of the unlocking control system of FIG. 7;

FIG. 13 is a simplified flow-chart depicting a method for securely storing valuable items according to the present invention;

FIG. 14 is a front elevational view of a first alternate embodiment of a security storage apparatus according to the present invention; and

FIG. 15 is a front elevational view of a second alternate embodiment of a security storage apparatus according to the present invention.

### DETAILED DESCRIPTION OF A PREFERRED EMBODIMENT

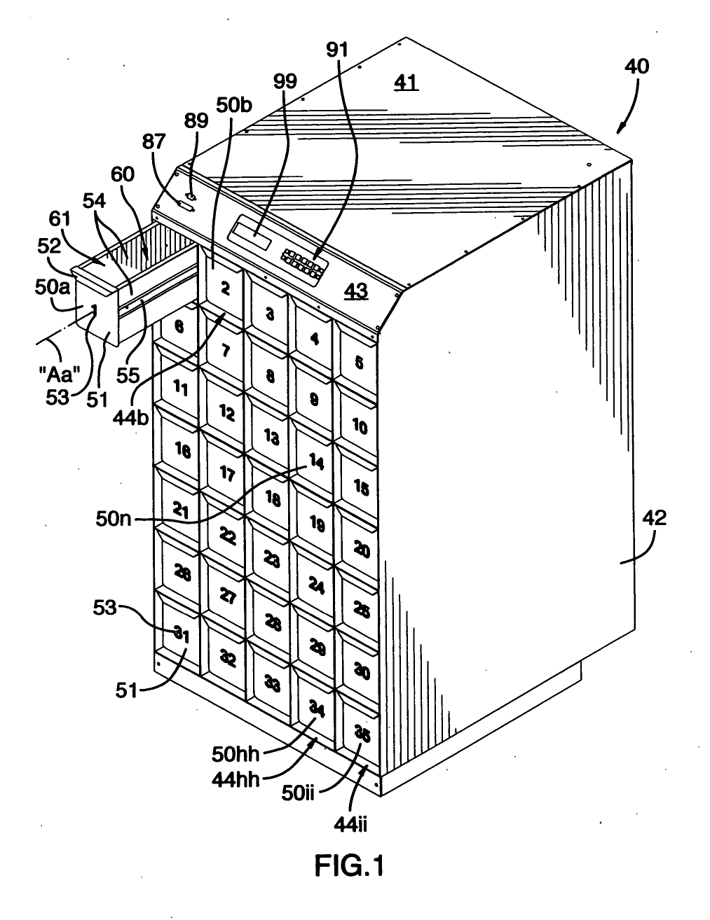

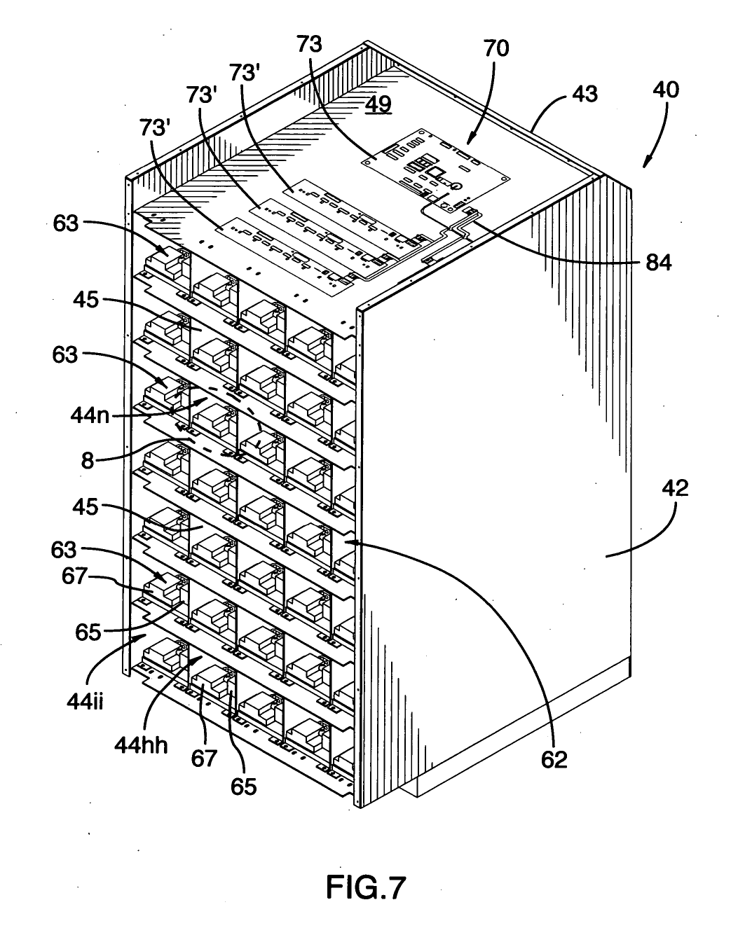

Referring now to FIGS. 1 through 12 of the drawings, there is shown a multiple enclosure security storage apparatus 40 for storing valuable items. The security storage apparatus 40 includes a housing 42 with a plurality of drawers, 50a through 50ii, an electrically actuable locking apparatus 62 (best seen in FIG. 7) associated with each of the drawers, 50a to 50ii, and an unlocking control system 70 operably connected to the locking apparatus 62.

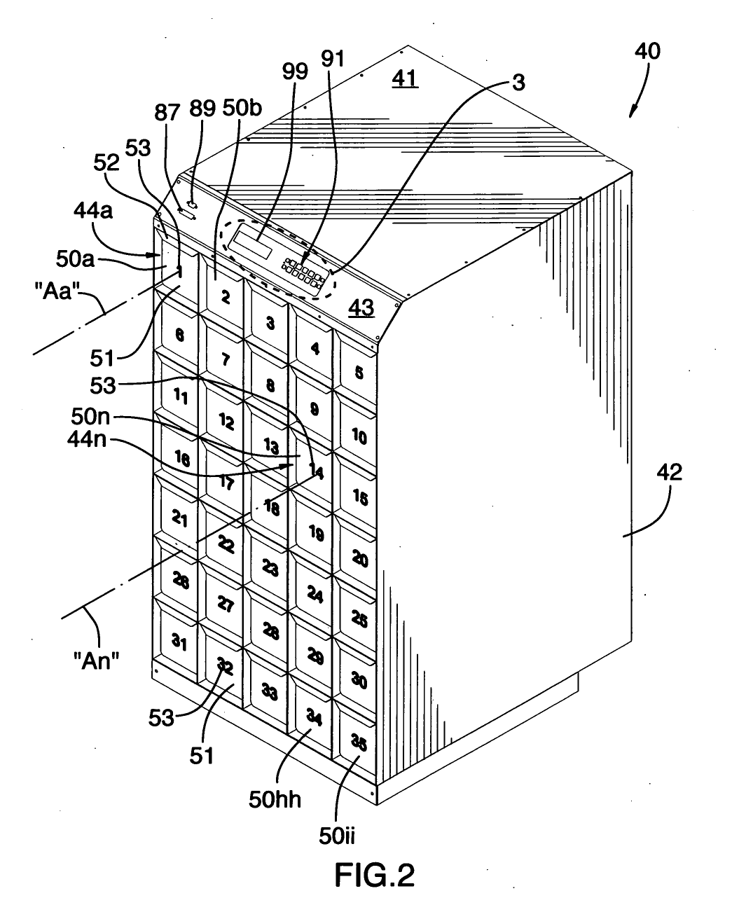

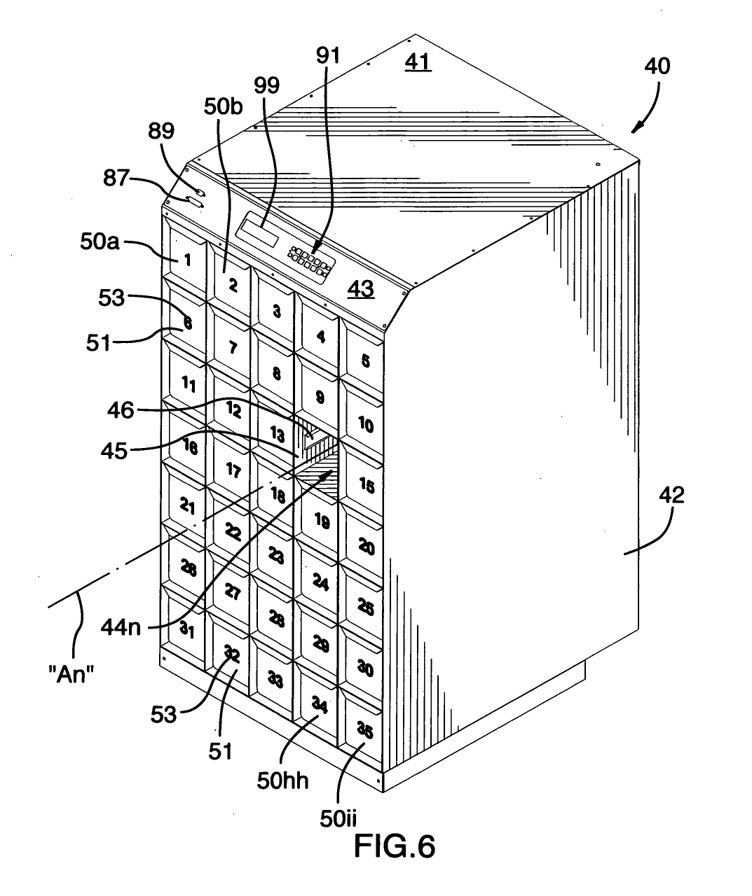

The housing 40 is preferably shaped and dimensioned to be installed within an existing safe or vault (not shown). As shown in FIGS. 1, 2, 5 and 6, the housing 42 is also preferably shaped so as to define a plurality of outward-facing drawer slots, 44a through 44ii. As best seen in FIG. 6, which shows drawer 50n removed from the apparatus 40 for ease of illustration, the outward-facing drawer slot 44n is preferably forward-facing, as will be further described hereinbelow. Each drawer slot 44 of the plurality of drawer slots, 44a to 44ii, defines a longitudinal axis; for example, and as best seen in FIG. 2, drawer slot 44a defines corresponding longitudinal axis “Aₐ”, and drawer slot 44n defines corresponding longitudinal axis “Aₙ”. At this time, it is noted that drawer slots 44a, 44b, 44hh and 44ii are best seen in FIGS. 1 and 2, and drawer slot 44n is best seen in FIGS. 2 and 6.

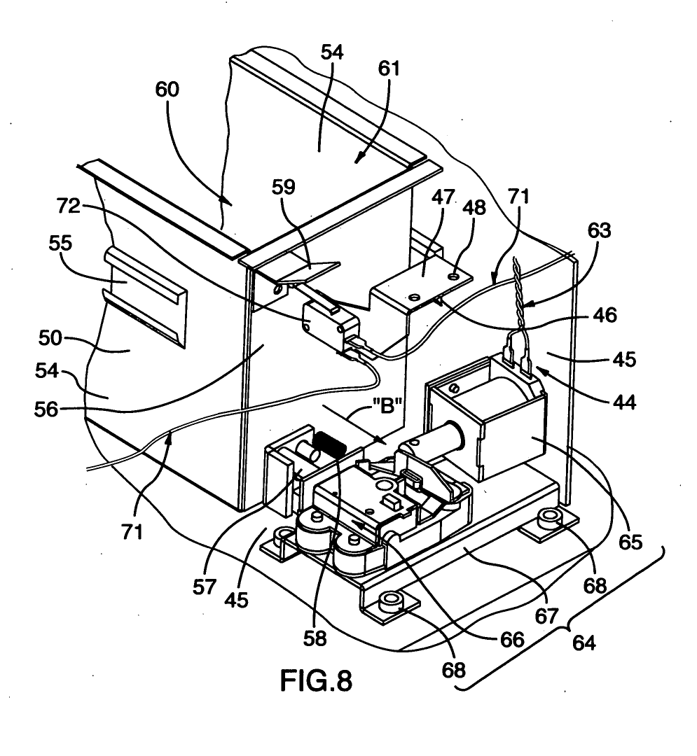

As best seen in FIG. 8, each drawer slot 44 receives one enclosure or drawer 50 in longitudinally sliding relation therein. That is and as shown in FIGS. 1, 2, 5 and 6, each drawer slot 44 of the plurality of drawer slots, 44a to 44ii, receives in longitudinally sliding relation therein a corresponding one drawer 50 of the plurality of drawers, 50a to 50ii.

As best seen in FIGS. 6, 8 and 11, each drawer slot 44 is defined by longitudinal slot walls 45 of the housing 42. In the preferred embodiment, and as best appreciated from FIGS. 1, 5, 6 and 8, two side slot walls 45 have longitudinal slot track members 46 securely mounted thereto. Each drawer 50 of the plurality of drawers, 50a to 50ii, has a front wall 51 (best seen in FIGS. 1, 2, 5 and 6), a rear wall 56 (best seen in FIGS. 8 through 11), and a number of intermediate longitudinal drawer walls 54. Together, these walls 51, 54, 56, define an interior storage compartment 60 that is adapted to store valuable items (not shown), and a storage aperture 61 leading into the interior storage compartment 60. In the preferred embodiment, and as best appreciated from FIGS. 1, 5, 8 and 9, two side drawer walls 54 have longitudinal mating drawer track members 55 securely mounted thereto. Each of the slot track members 46 engages a corresponding one of the mating drawer track members 55 in longitudinally sliding relation.

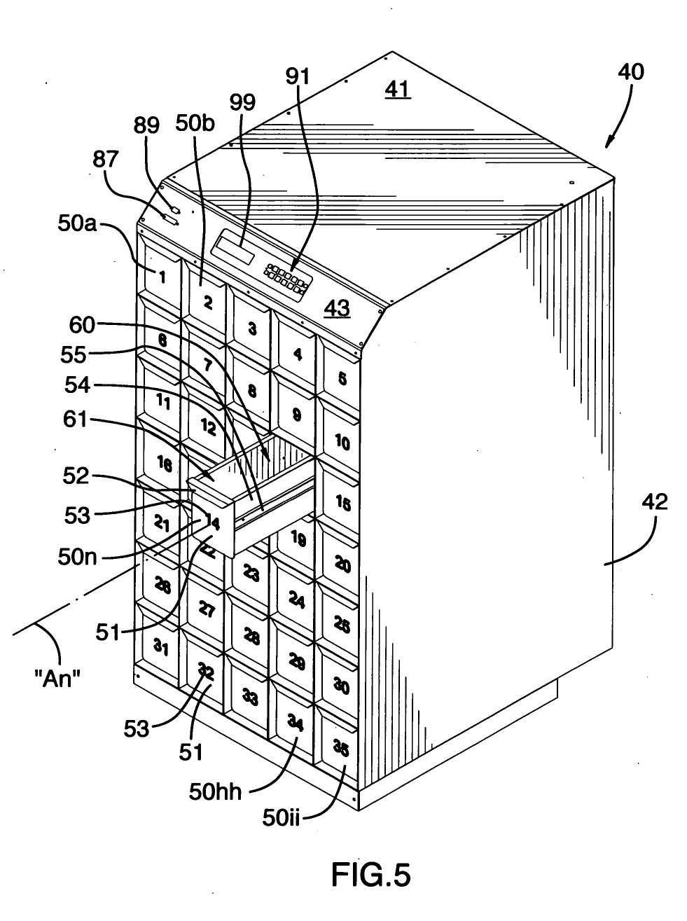

Each drawer 50 is movable between a closed configuration (as best seen in FIG. 2) and an open configuration (as best seen in FIGS. 1 and 5). In the closed configuration, and as best seen in FIG. 2, each drawer, 50a and 50n, is received within its corresponding drawer slot, 44a and 44n respectively, such that its storage aperture 61 and access to its storage compartment 60 are substantially obstructed. As best seen in FIG. 1, in the open configuration, drawer 50a is outwardly displaced from the closed configuration along its longitudinal axis “Aₐ”, such that its storage aperture 61 is substantially unobstructed, and so as to permit ready access into its storage compartment 60. Likewise, as best seen in FIG. 5, in the open configuration, drawer 50n is outwardly displaced from the closed configuration along its longitudinal axis “Aₙ”, such that its storage aperture 61 is substantially unobstructed, and so as to permit ready access into its storage compartment 60. At this time, it is noted that drawers 50a, 50b, 50n, 50hh and 50ii are best seen in FIGS. 1, 2 and 5.

The front wall 51 of each drawer 50 is provided with a handle 52 to facilitate movement between the open and closed configurations. In addition, drawer labeling indicia 53 are displayed from the front walls 51 so as to permit ready identification of each drawer 50. In the preferred embodiment, and as shown in FIGS. 1, 2, 5 and 6, the drawer labeling indicia 53 are sequential Arabic numerals, 1 through 35, which are displayed one each from the drawers, 50a through 50ii respectively.

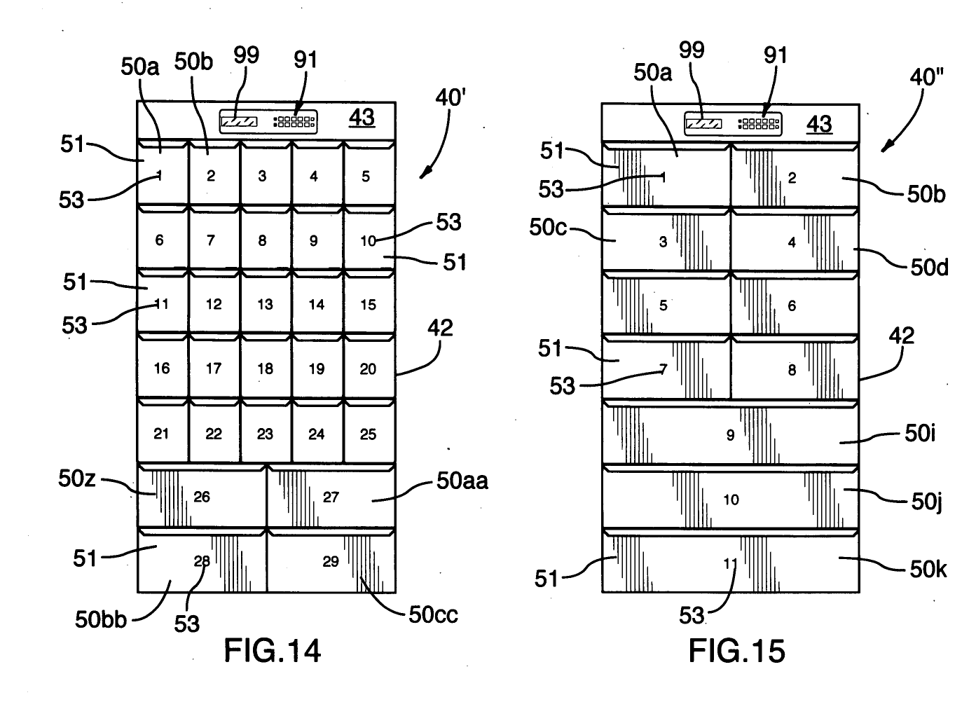

Naturally, the housing 42 may contain different numbers and arrangements of drawers 50 and drawer labeling indicia 53. FIG. 14 depicts a first alternate embodiment of the security storage apparatus 40′ having twenty-nine drawers, 50a through 50 cc. Each of the drawers, 50a through 50 cc, displays a respective one of the drawer labeling indicia 53 which consist of sequential Arabic numerals, 1 through 29 respectively. Similarly, FIG. 15 depicts a second alternate embodiment of the security storage apparatus 40″ having eleven drawers, 50a through 50k. Each of the drawers, 50a through 50k, displays a respective one of the drawer labeling indicia 53 which consist of sequential Arabic numerals, 1 through 11 respectively. At this time, it is noted that drawers 50z, 50aa and 50bb are best seen in FIG. 14, and drawers 50c, 50d, 50i and 50j are best seen in FIG. 15. It is also noted that, although the figures depict the drawer labeling indicia 53 as sequential Arabic numerals, any other readily identifiable indicia 53 might just as easily be used, including other alphanumeric characters, as well as words, symbols, geometric shapes and colors (or combinations of any of the foregoing).

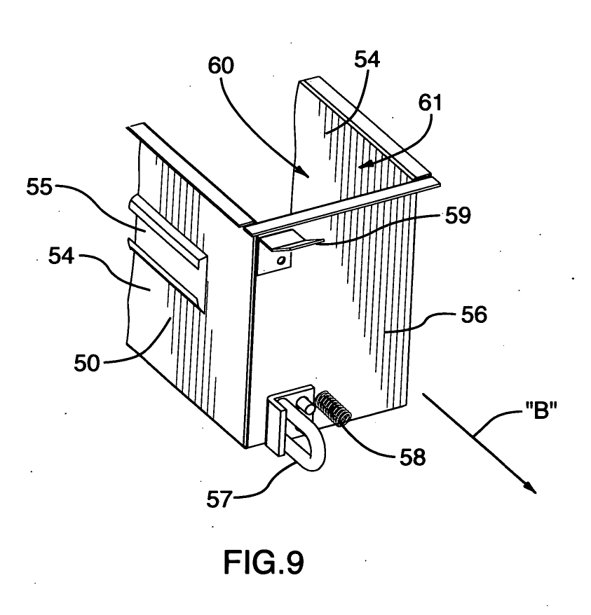

As best seen in FIGS. 8 and 9, the rear wall 56 of each drawer 50 has a U-bolt 57 and a drawer status switch contact 59 securely extending therefrom in a substantially rearward direction (as indicated by arrow “B” in FIGS. 8 and 9).

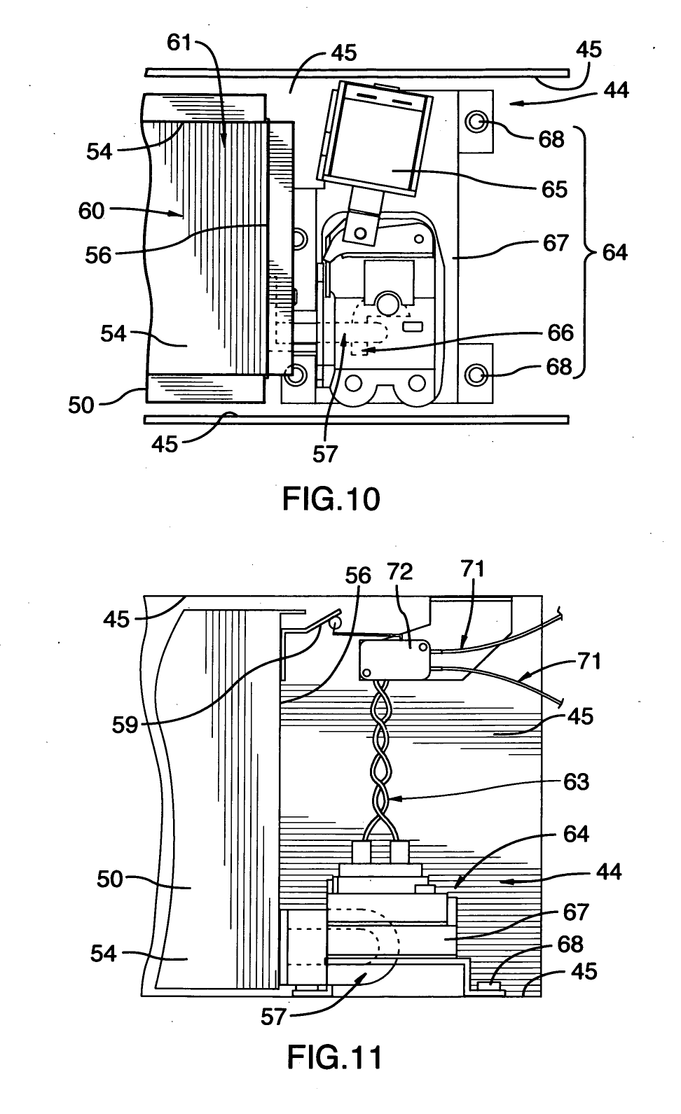

Preferably, and as best seen in FIG. 7, the locking apparatus 62 comprises a plurality of drawer locking subsystems 63. As best seen in FIGS. 8, 10 and 11, each of the drawer locking subsystems 63 is associated with a respective one of the drawer slots, 44a to 44ii, and with a respective one of the drawers, 50a to 50ii. As best seen in FIG. 8, each of the drawer locking subsystems 63 includes an electrically actuable lock assembly 64 securely mounted on a lock mounting bracket 67 which is preferably securely affixed to a bottom slot wall 45 by a plurality of lock mounting fasteners 68. As best seen in FIG. 10, the electrically actuable lock assembly 64 includes a latch member 66 and a solenoid 65 operably connected to the unlocking control system 70. Each solenoid 65 is adapted to move it respective latch member 66 and drawer 50 between a locked configuration (as best seen in FIGS. 2, 8, 10 and 11) and an unlocked configuration (as best seen in FIGS. 1, 5 and 9).

In the locked configuration, and as best seen in FIG. 10, the latch member 66 of the lock assembly 64 securely engages the U-bolt member 57 extending from the rear wall 56 of the drawer 50. As such, the drawer 50 is substantially securely maintained in the closed configuration. Preferably, the locked configuration is also a default configuration, such that each of the drawers 50 is maintained in the locked configuration in the event of a power failure or interruption.

In the unlocked configuration, and as best appreciated from FIG. 9, the U-bolt member 57 extending from the rear wall 56 of the drawer 50 is disengaged from the latch member 66 of the electrically actuable lock assembly 64. As such, in the unlocked configuration, and as best seen in FIGS. 5 and 9, the drawer 50n may be outwardly displaced in a substantially forward direction (i.e., in a direction substantially opposed to the rearward direction “B”) along the longitudinal axis “Aₙ” so as to readily move the drawer 50n from the closed configuration towards the open configuration shown in FIG. 5.

At this time, it is of course to be appreciated that, as best seen in FIG. 6, the forward-facing drawer slot 44 preferably also faces in the forward direction (i.e., in the direction substantially opposed to the rearward direction “B”, best seen in FIGS. 8 and 9).

As best seen in FIGS. 8 and 9, each of the drawers 50 includes a spring biasing means 58, preferably a coil spring mounted to the rear wall 56, for biasing the drawer 50 towards the open configuration. Naturally, it will be appreciated that according to the present invention, other forms of biasing means might be used to bias the enclosure 50 towards the open configuration, including gravity biasing means and other types of springs mounted to the same or different portions of the slot 44, drawer 50, track members 46, 55, or locking apparatus 62.

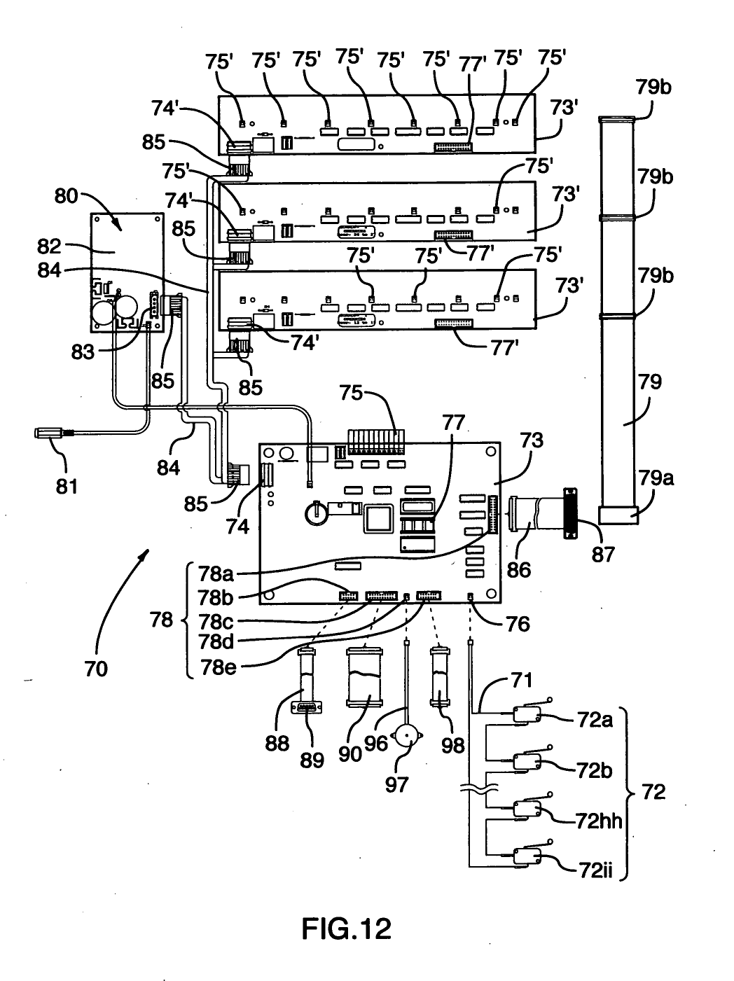

In the preferred embodiment, the unlocking control system 70 is securely mounted, beneath a top panel 41 (best seen in FIGS. 1, 2, 5 and 6) of the housing 42, to a control mounting panel 49 (best seen in FIG. 7). As best seen in FIG. 12, the unlocking control system 70 includes a power subsystem 80, a main circuit board 73, three expansion circuit boards 73′, and an enclosure status subsystem 71. The power subsystem 80 includes an external power supply plug 81 which is adapted to be operably connected to an external power supply (not shown). As best seen in FIG. 12, the external power supply plug 81 is connected to a power converter circuit board 82. A board powering cable 84 preferably has five power plugs 85, with one of the power plugs 85 being operably connected to a power connector 83 provided on the power converter circuit board 82. The remaining power plugs 85 are operably connected one each to power subsystem connectors 74, 74′ which are provided on the main circuit board 73 and on each of the expansion circuit boards 73′. In this manner, power is provided from the power subsystem 80 to the main circuit board 73 and to each of the expansion circuit boards 73′.

As best seen in FIG. 12, the main circuit board 73 and the expansion circuit boards 73′ are preferably each provided with locking subsystem connectors, 75 and 75′ respectively. The main circuit board 73 is preferably provided with eleven locking subsystem connectors 75, and each of the expansion circuit boards 73′ is preferably provided with eight locking subsystem connectors 75′. Each of the locking subsystem connectors 75, 75′ is adapted to be operably connected to one of the drawer locking subsystems 63 in operable connection to the solenoid 65 (best seen in FIG. 8). It is therefore to be appreciated that each of the locking subsystem connectors 75, 75′ is associated with a respective one of the drawers, 50a to 50ii.

The main circuit board 73 and the expansion circuit boards 73′ are preferably further provided one each with an expansion control connector, 77 and 77′ respectively. As best seen in FIG. 12, an expansion control cable 79 is preferably provided with a main circuit board plug 79a and three expansion circuit board plugs 79b. The main circuit board plug 79a of the expansion control cable 79 is adapted to be operably connected to the expansion control connector 77 on the main circuit board. The expansion circuit board plugs 79b are adapted to be operably connected one each with the expansion control connectors 77′ on each of the expansion circuit boards 73′. In this manner, the main circuit board 73 is preferably operably connected to each of the expansion circuit boards 73′.

As shown in FIG. 12, the main circuit board 75 is preferably further provided with a number of user interface connectors 78. The user interface connectors 78 preferably include a printer connector 78a, a modem connector 78b, a user input device connector 78c, a buzzer connector 78d, and a display connector 78e. A buzzer cable 96 operably connects the buzzer connector 78d on the main circuit board 73 to a sound wave generating means, preferably a buzzer 97, for generating and transmitting a sound wave signal (not shown) from the apparatus 40. Preferably, the sound wave signal is an audible alert tone that is transmitted within a hearing range of the user.

As shown in FIG. 12, the main circuit board 73 is preferably also provided with an enclosure status subsystem connector 76, with the enclosure status subsystem 71 being adapted to be operably connected thereto. The enclosure status subsystem 71 preferably includes a plurality of drawer status switches, 72a through 72ii, operably connected to one another. It is noted that, for ease of illustration, FIG. 12 depicts drawer status switches 72a, 72b, 72hh and 72ii.

As best seen in FIGS. 8 and 11 (which each show a representative one status switch 72 of the plurality 72a to 72ii), each status switch 72 is associated with a respective one of the drawers 50. It is therefore to be appreciated that each respective one of the status switches, 72a to 72ii, shown in FIG. 12 is associated with one of the drawer slots, 44a to 44ii respectively, and with one of the drawers, 50a to 50ii respectively.

As shown in FIGS. 8 and 11, each of the status switches 72 is preferably securely mounted on a switch mounting bracket 47 that defines mounting apertures 48, so as to enable the bracket 47 to be securely affixed to a top slot wall 45 (best seen in FIG. 11). Each of the status switches 72 is adapted to determine when its respective drawer 50 is either in the locked or the unlocked configuration. In the locked configuration, and as best seen in FIGS. 8 and 11, the drawer status switch contact 59 extending in the rearward direction “B” from the rear wall 56 of the drawer 50 engages the corresponding status switch 72. Conversely, in the unlocked configuration, and as best appreciated from FIG. 9, the drawer status switch contact 59 of the drawer 50 is removed from engagement with the status switch 72.

When the enclosure status subsystem 71 identifies that any one of the drawers 50 is in the unlocked configuration (as shown in FIGS. 1, 5 and 9), the unlocking control system 70 disables all of the locking subsystem connectors 75, 75′ from moving the solenoids 65, latch members 66, and drawers 50 towards the unlocked configuration. The unlocking control system 70 only enables the locking subsystem connectors 75, 75′ to move a selected one solenoid 65, latch member 66 and drawer 50 towards the unlocked configuration when the enclosure status subsystem 71 identifies that each and every one of the drawers 50 is in the locked configuration (as best seen in FIG. 2).

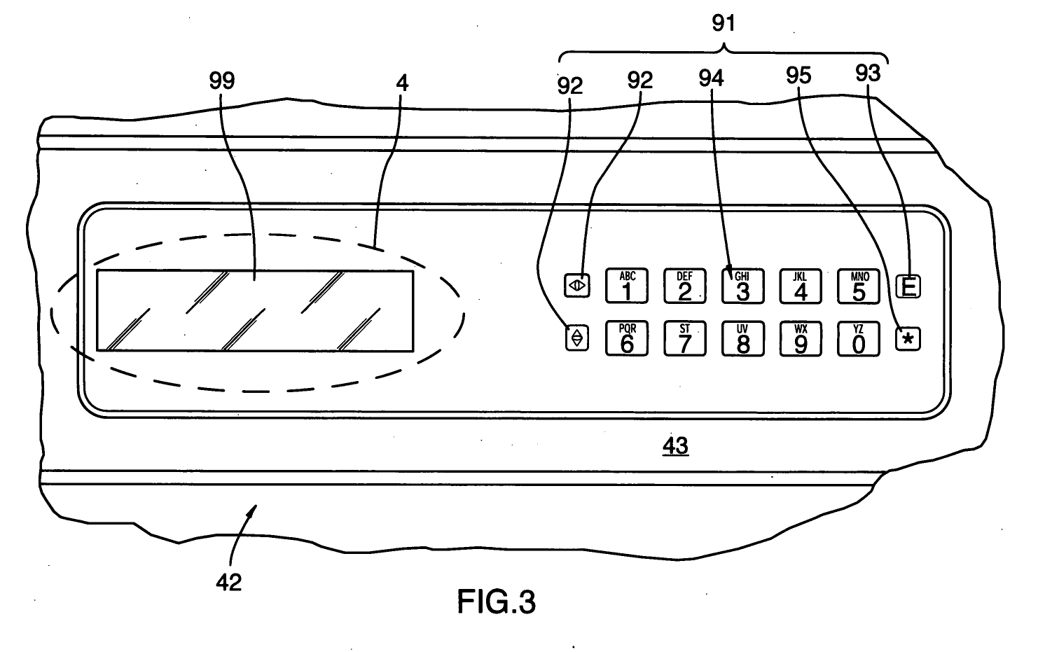

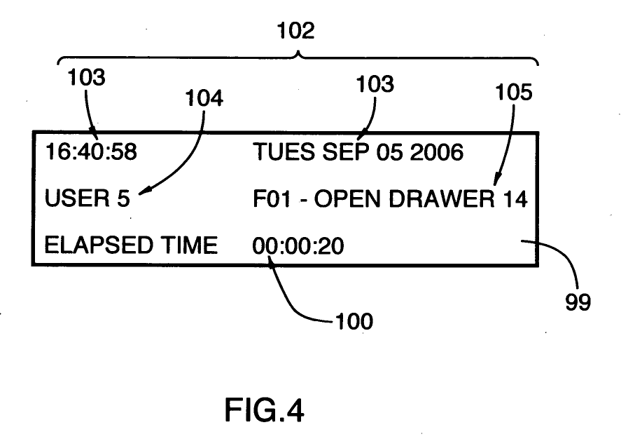

The unlocking control system 70 is preferably further adapted to delay movement of the drawers 50 towards the unlocked configuration by a predetermined time delay interval. A display cable 98 operably connects the display connector 78e on the main circuit board 73 to a display means, preferably a liquid crystal display 99 (as best seen in FIG. 3), for displaying an upward counting elapsed time indicia 100 (as best seen in FIG. 4) over a substantial duration of the predetermined time delay interval. As best seen in FIGS. 1 through 6, the liquid crystal display 99 is securely mounted to an inclined front face 43 of the housing 41 within view of a user (not shown) of the apparatus 40.

The unlocking control system 70 is preferably still further adapted to disable movement of any selected drawer 50 towards the unlocked configuration at predetermined lock-down times and dates. In this manner, access to the drawers 50 of the apparatus 40 may be restricted to certain times and/or days of the week. This feature is particularly beneficial in ensuring that the drawers 50 are locked down, and access to the apparatus 40 is restricted, during non-business hours and days.

A user input cable 90 operably connects the user input connector 78c on the main circuit board 73 to a user input device, preferably a keypad 91 (as best seen in FIG. 3) that is operably positioned within reach of the user of the apparatus 40. As shown in FIGS. 1 through 6, the keypad 91 is preferably securely mounted to the inclined front face 43 of the housing 41. The keypad 91 preferably includes scroll keys 92, an enter key 93, alphanumeric keys 94, and a correction/exit key 95.

The unlocking control system 70 is preferably adapted to only enable any selected drawer 50 to be unlocked after the keypad 91 has been used to enter an authorized user identification datum 104. The keypad 91 and the unlocking control system 70 are preferably further adapted to enable the entry of a unique identification datum 104 for each different authorized user of the apparatus 40.

In the preferred embodiment, the unlocking control system 70 is preferably adapted to enable differing access to the drawers, 50a to 50ii, depending on the authorized user identification datum 104 that is entered on the keypad 91. For example, the entry of a first authorized user identification datum 104 might prevent a first user (not shown) from unlocking a first predetermined subset of the drawers 50a to 50ii, while the entry of a second authorized user identification datum 104 might prevent a second user (not shown) from unlocking a second predetermined, yet completely different, subset of the drawers 50a to 50ii. Alternately, the second predetermined subset may be identical to, or only partially overlapping with, the first predetermined subset.

The unlocking control system 70 is also adapted to selectively enable an authorized bypass user, such as for example an armored car carrier (not shown), to unlock a selected drawer 50 without waiting for an intervening passage of the predetermined time interval. Preferably, the authorized bypass user must use the keypad 91 to enter his unique user identification datum 104 before enabling a selected drawer 50 to be unlocked without the intervening passage of the predetermined time interval.

Using the keypad 91, an authorized supervising user (not shown) of the apparatus 40 may manually adjust and set the predetermined time delay interval and the predetermined lock-down times and dates. Preferably, the predetermined time interval is substantially adjustable; for example, the predetermined time interval may be adjustable substantially within the range of between two and ninety-nine seconds. Preferably, the authorized supervising user may also manually adjust and set user permissions which afford access to the drawers, 50a to 50ii, upon entry of the authorized user identification data 104. That is, and for example, the authorized supervising user might modify the drawers, 50a to 50ii, which might be accessed by a user following entry of the first and/or second authorized user identification data 104, thereby respectively altering the first and/or second predetermined subsets.

The unlocking control system 70 is preferably adapted to enable the recording of event data 102 (i) when any selected one of the drawers 50 is moved towards the unlocked configuration; (ii) when the authorized bypass user (not shown) enters his unique user identification datum 104; (iii) when an authorized supervising user adjusts the predetermined time delay interval, (iv) when an authorized supervising user adjusts the predetermined lock-down times and dates, and (v) when an authorized supervising user adjusts any user permissions and access to the drawers 50a to 50ii. As best seen in FIG. 4, the event data 102 which is recorded using the unlocking control system 70 preferably includes the user identification datum 104, a time signature datum 103, and an enclosure identification datum 105 (if appropriate).

Any event data 102 that has been recorded using the unlocking control system 70 may be selectively accessed and reviewed by the authorized supervising user (not shown) of the apparatus 40. To this effect, a printer cable 86 operably connects the printer connector 78a on the main circuit board 73 to a printer port 87. The printer port 87 is preferably securely mounted to the inclined front face 43 of the housing 41. With a printer (not shown) connected to the printer port 87, the authorized supervising user may access the event data 102 and obtain a printed copy of same for review and archiving. Similarly, a modem cable 88 operably connects the modem connector 78b on the main circuit board 73 to a modem port 89. The modem port 89 is preferably securely mounted to the inclined front face 43 of the housing 41. With a computer (not shown) connected to the modem port 89, the authorized supervising user may access the event data 102 and display same thereon for his review or archiving. Alternately, and as shown in FIG. 4, the event data 102 may be displayed from the liquid crystal display 99 that is mounted to the inclined front face 43 of the housing 41.

In use, the security storage apparatus 40 requires the user to lock all of the enclosures 50 before enabling the opening of another. The apparatus 40, being further equipped to delay the unlocking of any selected enclosure 50 by the predetermined time delay interval, will significantly delay any armed robbery attempts. In so doing, the apparatus 40 facilitates the timely attendance of security and police authorities on site and reduces the possibility that a thief might escape after substantially emptying a pawn shop or bank of valuable contents. The use and prominent display of the security storage apparatus 40 on the premises of a pawn shop or bank naturally reduces the number of armed robbery attempts made upon such businesses, since both inexperienced and seasoned thieves are generally drawn to easy targets that may be efficiently relieved of valuable items, with minimal risk of arrest. The security storage apparatus 40 is intended to be installed within an existing safe (not shown), and the drawers 50 are preferably adapted to store pawn shop envelopes, such that the security storage apparatus 40 is suitable for use in pawn shops.

The use of the security storage apparatus 40 enables the authorized supervising user (not shown) to (i) manually adjust and set the predetermined time delay interval for unlocking the drawers 50, and (ii) select different levels of access for different users, enclosures, dates and times. The use of the security storage apparatus 40 additionally enables the authorized bypass user (not shown) to selectively unlock the drawers 50 without waiting for intervening passage of the predetermined time delay interval.

As aforesaid, the security storage apparatus 40 is adapted to record the event data 102 (including user identification data 104, time signature data 103, and enclosure identification data 105) any time a user unlocks a drawer 50, manually adjusts or sets a time delay, bypasses a time delay, or changes user permissions. Further, with the predetermined time delay interval preferably being adjustable substantially within the range of between two and ninety nine seconds, the use of the security storage apparatus 40 minimally delays an authorized user during its normal operation.

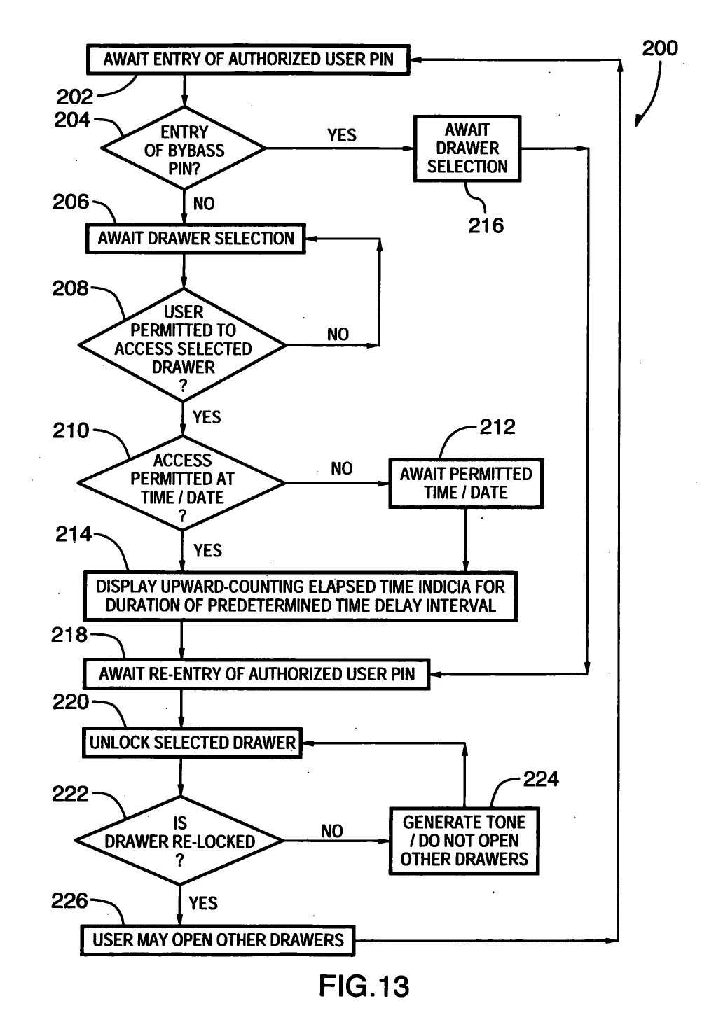

A simplified presentation of a method 200 for securely storing valuable items, according to the invention, is shown in FIG. 13. Although the method 200 is described with reference to the security storage apparatus 40 shown in FIGS. 1 through 12, the method 200 might just as easily be performed by a security storage apparatus having a substantially different configuration and consisting of substantially different component elements.

Initially, in the preferred embodiment, the method 200 starts at step 202 where it awaits entry of a user identification datum 104 by an authorized user of the apparatus 40. The method 200 proceeds to step 204, where a query determines whether an authorized bypass user has entered a user identification datum 104.

If no such authorized bypass user has entered a user identification datum 104, the method 200 proceeds to step 206, where it awaits selection of a drawer 50 which is to be unlocked by the authorized user. The method 200 then proceeds to step 208, where it queries whether the authorized user is permitted to access the selected drawer 50. If the authorized user is not so permitted, the buzzer 97 of the apparatus 40 may generate a tone, and the method 200 returns to step 206. Once a drawer 50 has been selected that the authorized user is permitted to access, the method 200 proceeds to step 210, where it queries whether access to the drawer 50 is permitted at the current time and date. In the event that such access is then permitted, the method 200 proceeds to step 214 without delay. If, however, access to the drawer 50 is not permitted at that particular time or date, the method proceeds to step 212, where it awaits the permitted time and date for accessing the drawer 50, before proceeding to step 214.

At step 214, the method commences display of an upward-counting elapsed time indicia for a substantial duration of a predetermined time delay interval. On expiry of the time delay interval, the method 200 proceeds to step 218.

In the event that, in step 204, the query determines that the authorized bypass user entered a user identification datum 104, the method 200 will alternately proceed to step 206, where it will await selection of a drawer 50 which is to be unlocked by the authorized bypass user. Following drawer selection, the method 200 proceeds to step 218 without intervening passage of the time delay interval.

At step 218, the method 200 awaits re-entry of the user identification datum 104 by the authorized user of the apparatus 40. The method 200 then proceeds to step 220, where the selected drawer 50 is unlocked. The authorized user and/or the authorized bypass user may then conduct any necessary transactions in the unlocked drawer 50. The method 200 then proceeds to step 222, where it queries whether the drawer 50 has been re-locked. If the drawer 50 has not been re-locked, the method 200 proceeds to step 224, whereupon the buzzer 97 of the apparatus 40 may generate a warning tone and the unlocking of other drawers 50 is still impeded, before returning to step 222. Once the drawer 50 has been re-locked, the method 200 proceeds to step 226, with the authorized user thereafter being able to open other drawers 50 and with the method 200 returning to initial step 202.

Other modifications and alterations may be used in the design and manufacture of other embodiments according to the present invention without departing from the spirit and scope of the invention, which is limited only by the accompanying claims. For example, the security storage apparatus 40 might be provided with alternate forms of enclosures, including enclosures with swinging front doors among others, and regardless of whether any such enclosures are substituted for, or in combination with, the drawers 50 that are shown in the accompanying figures. Of course, any different numbers and configurations of enclosures are likewise permitted. Also, the unlocking control system 70 might include a computer that is situated outside of the housing 42, such as for example a personal computer (not shown). A number of those functions which are specified herein as being performed by the depicted elements of the unlocking control system 70 might instead be performed by or through such a computer. For example, a computer of the unlocking control system 70 that is situated outside of the housing 42 might perform functions relating to the display to the upward-counting elapsed time indicia 100, relating to the time delay interval, on behalf of the authorized supervising user or otherwise, or relating to user input through the computer keyboard rather than through the keypad 90 that is mounted to the housing 42. Additionally, the security storage apparatus 40 might be installed within a safe (not shown) that is specifically shaped and dimensioned to receive it, or it might be installed inside of a larger vault (not shown). Likewise, the security storage apparatus 40 might not be installed within a safe or vault at all, but rather might on its own be designed to at least temporarily withstand prying, wedging and disassembly attacks. Also, the modem port 89 might allow remote access and control by a user, or it might merely enable connection to a computer that is situated outside of the housing 42 as aforesaid. Given the various alternate embodiments of the security storage apparatus 40 according to the present invention, of which the preceding named embodiments are merely examples, it is perhaps worthwhile to once again note that the invention is limited only by the accompanying claims.

I claim:

1. A multiple enclosure security storage apparatus for storing valuable items, said apparatus comprising:
a) a housing comprising a plurality of enclosures, with each enclosure of said plurality defining an interior storage compartment that is adapted to store valuable items, and with each said enclosure being movable between a closed configuration and an open configuration; wherein in said closed configuration, access to said storage compartment is substantially obstructed; and in said open configuration, said storage compartment is substantially readily accessible;
b) an electrically actuable locking apparatus associated with each said enclosure, said locking apparatus being adapted to selectively move said enclosure between a locked configuration and an unlocked configuration; wherein in said locked configuration, said enclosure is substantially securely maintained in said closed configuration; and wherein in said unlocked configuration, said enclosure is substantially readily movable between said closed configuration and said open configuration; and
c) an unlocking control system operably connected to said locking apparatus, said unlocking control system being adapted to disable movement of all said enclosures from said locked configuration towards said unlocked configuration when at least one said enclosure is in said unlocked configuration, and with said unlocking control system further adapted to enable selective movement of a selected one said enclosure from said locked configuration towards said unlocked configuration when all said enclosures are in said locked configuration.

2. A multiple enclosure security storage apparatus according to claim 1, wherein said unlocking control system comprises an enclosure status subsystem having a plurality of status switches operably connected to one another, with each of said status switches associated with a respective one of said enclosures and adapted to determine when said respective one is in said unlocked configuration.

3. A multiple enclosure security storage apparatus according to claim 2, wherein in said locked configuration, said respective one of said enclosures engages a corresponding one of said status switches; and in said unlocked configuration, said respective one of said enclosures is removed from said corresponding one of said status switches.

4. A multiple enclosure security storage apparatus according to claim 1, wherein said locking apparatus comprises locking subsystems operably connected to said unlocking control system, with each of said locking subsystems associated with a respective one said enclosure; wherein each of said locking subsystems comprises an electrically actuable lock assembly having a latch member; wherein in said locked configuration, said latch member securely engages said respective one said enclosure; and wherein in said unlocked configuration, said latch member is disengaged from said enclosure.

5. A multiple enclosure security storage apparatus according to claim 4, wherein said electrically actuable lock assembly comprises a solenoid operably connected to said unlocking control system and adapted to move said latch member between said locked configuration and said unlocked configuration.

6. A multiple enclosure security storage apparatus according to claim 1, wherein each of said plurality of enclosures comprises a drawer, and wherein said housing is shaped so as to define a corresponding plurality of outward-facing drawer slots, with each drawer slot of said corresponding plurality defining a longitudinal axis and receiving one said drawer in longitudinally sliding relation therein, and with each said drawer defining a through-passing storage aperture into a respective said storage compartment; wherein in said closed configuration, said drawer is received within said drawer slot, such that said storage aperture is substantially obstructed; and wherein in said open configuration, said drawer is outwardly displaced from said closed configuration along said longitudinal axis, such that said storage aperture is substantially unobstructed, and such as to permit the aforesaid ready access into said storage compartment.

7. A multiple enclosure security storage apparatus according to claim 6, wherein said locking apparatus comprises locking subsystems operably connected to said unlocking control system, with each of said locking subsystems associated with a respective one said enclosure, and with each of said locking subsystems comprising an electrically actuable lock assembly having a latch member; wherein each said drawer comprises a rear wall having a U-bolt member securely extending therefrom in a substantially rearward direction; wherein in said locked configuration, said latch member securely engages said U-bolt member; and wherein in said unlocked configuration, said latch member is disengaged from said U-bolt member, so as to permit the aforesaid outward displacement of said drawer along said longitudinal axis.

8. A multiple enclosure security storage apparatus according to claim 6, wherein each of said drawer slots is defined by longitudinal slot walls of the housing, with at least one of said slot walls having a longitudinal slot track member securely mounted thereto; and wherein each said drawer comprises longitudinal drawer walls, with at least one of said drawer walls having a longitudinal mating drawer track member securely mounted thereto; with said slot track member engaging said mating drawer track member in said longitudinally sliding relation.

9. A multiple enclosure security storage apparatus according to claim 6, wherein each said drawer comprises a rear wall and spring biasing means, mounted to said rear wall, for biasing said drawer towards said open configuration.

10. A multiple enclosure security storage apparatus according to claim 1, wherein said unlocking control system is adapted to delay the aforesaid selective movement of said selected enclosure towards said unlocked configuration by a predetermined time interval.

11. A multiple enclosure security storage apparatus according to claim 10, wherein said predetermined time interval is preselected by a user of the apparatus.

12. A multiple enclosure security storage apparatus according to claim 11, wherein said unlocking control system is adapted to record event data when said predetermined time interval is preselected by the user of the apparatus.

13. A multiple enclosure security storage apparatus according to claim 10, wherein said unlocking control system further comprises a display means for displaying, within view of a user of the apparatus, an upward-counting elapsed time indicia over a substantial duration of said predetermined time interval.

14. A multiple enclosure security storage apparatus according to claim 13, wherein said display means comprises a liquid crystal display.

15. A multiple enclosure security storage apparatus according to claim 10, wherein said predetermined time interval is substantially within the range of between two and ninety-nine seconds.

16. A multiple enclosure security storage apparatus according to claim 10, wherein said unlocking control system further comprises a user input device adapted to selectively enable the aforesaid selective movement of said selected enclosure towards said unlocked configuration without an intervening passage of said predetermined time interval.

17. A multiple enclosure security storage apparatus according to claim 16, wherein said user input device is further adapted to enable entry of an authorized bypass user identification datum, with said unlocking control system requiring the aforesaid entry of said authorized bypass user identification datum before enabling the aforesaid selective movement of said selected enclosure towards said unlocked configuration without said intervening passage of said predetermined time interval.

18. A multiple enclosure security storage apparatus according to claim 16, wherein said unlocking control system is adapted to record event data upon enabling the aforesaid selective movement of said selected enclosure towards said unlocked configuration without said intervening passage of said predetermined time interval.

19. A multiple enclosure security storage apparatus according to claim 1, further comprising biasing means for biasing each said enclosure towards said open configuration.

20. A multiple enclosure security storage apparatus according to claim 1, wherein said locked configuration is a default configuration, such that in the event of a power interruption, said locking apparatus maintains each said enclosure in said locked configuration.

21. A multiple enclosure security storage apparatus according to claim 1, wherein said unlocking control system comprises a user input device adapted to enable entry of a first authorized user identification datum, with said unlocking control system being adapted to only enable the aforesaid selective movement towards said unlocked configuration after entry of said first authorized user identification datum.

22. A multiple enclosure security storage apparatus according to claim 21, wherein said user input device comprises a keypad operably positioned within reach of a user of the apparatus.

23. A multiple enclosure security storage apparatus according to claim 21, wherein upon entry of said first authorized user identification datum, said unlocking control system is further adapted to inhibit movement of a first predetermined subset of said plurality of enclosures towards said unlocked configuration, with said first predetermined subset consisting of at least one said enclosure.

24. A multiple enclosure security storage apparatus according to claim 23, wherein said first predetermined subset is a user-preselected subset.

25. A multiple enclosure security storage apparatus according to claim 24, wherein said unlocking control system is adapted to record event data when said user-preselected subset is preselected.

26. A multiple enclosure security storage apparatus according to claim 23, wherein said user input device is further adapted to enable entry of a second authorized user identification datum; wherein upon entry of said second authorized user identification datum, said unlocking control system is further adapted to inhibit movement of a second predetermined subset of said plurality of enclosures towards said unlocked configuration, with said second predetermined subset consisting of at least one said enclosure.

27. A multiple enclosure security storage apparatus according to claim 26, wherein said second predetermined subset consists of at least one said enclosure that is excluded from said first predetermined subset.

28. A multiple enclosure security storage apparatus according to claim 26, wherein said unlocking control system is adapted to record a user identification datum when said selected one said enclosure is moved from said locked configuration towards said unlocked configuration.

29. A multiple enclosure security storage apparatus according to claim 1, wherein said unlocking control system is further adapted to disable movement from said locked configuration towards said unlocked configuration at a predetermined time.

30. A multiple enclosure security storage apparatus according to claim 1, wherein said unlocking control system is adapted to record event data when each said enclosure is moved from said locked configuration towards said unlocked configuration.

31. A multiple enclosure security storage apparatus according to claim 30, wherein said event data comprises an enclosure identification datum.

32. A multiple enclosure security storage apparatus according to claim 30, wherein said event data comprises a time signature datum.

33. A multiple enclosure security storage apparatus according to claim 1, wherein each said enclosure comprises a front wall and enclosure labeling indicia displayed from said front wall.

34. A multiple enclosure security storage apparatus according to claim 1, wherein said housing is shaped and dimensioned to be installed within an existing safe.

35. A multiple enclosure security storage apparatus for storing valuable items, said apparatus comprising:
a) a housing comprising a plurality of enclosures, with each enclosure of said plurality defining an interior storage compartment that is adapted to store valuable items, and with each said enclosure being movable between a closed configuration and an open configuration; wherein in said closed configuration, access to said storage compartment is substantially obstructed; and in said open configuration, said storage compartment is substantially readily accessible;
b) a locking means, associated with each said enclosure, for selective movement of said enclosure between a locked configuration and an unlocked configuration; wherein in said locked configuration, said enclosure is substantially securely maintained in said closed configuration; and wherein in said unlocked configuration, said enclosure is substantially readily movable between said closed configuration and said open configuration; and
c) an unlocking control means, operably connected to said locking means, for disabling movement of all said enclosures from said locked configuration towards said unlocked configuration when at least one said enclosure is in said unlocked configuration, and for enabling selective movement of a selected one said enclosure from said locked configuration towards said unlocked configuration only when all said enclosures are in said locked configuration.

36. A method for securely storing valuable items in a multiple enclosure security storage apparatus, with each enclosure of the apparatus being selectively electromechanically movable between a locked closed configuration and an unlocked configuration, said method comprising the steps of:
a) awaiting a user selection of a first enclosure to be electromechanically moved towards the unlocked configuration;
b) electromechanically moving said first enclosure towards the unlocked configuration;
c) electromechanically determining whether said first enclosure has been returned to the locked closed configuration;
d) if said first enclosure has not been returned to the locked closed configuration, electromechanically impeding movement of a second enclosure towards the unlocked configuration; and
e) if said first enclosure has been returned to the locked closed configuration, enabling movement of said second enclosure towards the unlocked configuration.

37. A method for securely storing valuable items according to claim 36, wherein said method comprises an additional step, after step (a), of:
a.1) electronically delaying advancement to step (b) by a predetermined time delay interval.

38. A method for securely storing valuable items according to claim 37, wherein in step (a.1), said method comprises a further additional step of displaying an upward-counting elapsed time indicia, within view of the user, for a substantial duration of said predetermined time delay interval.

39. A method for securely storing valuable items according to claim 36, wherein said method comprises an additional initial step of:
i) electronically delaying advancement to step (a) until the user enters a user identification datum for a first time.

40. A method for securely storing valuable items according to claim 39, wherein said method comprises an additional step of:
a.1) electronically delaying advancement to step (b) until the user enters said user identification datum for a second time.

41. A method for securely storing valuable items according to claim 39, wherein said method comprises additional steps of:
ii) electronically determining whether said user identification datum is a time delay bypass datum;
a.1) if said user identification datum is not said time delay bypass datum, electronically delaying advancement to step (b) by a predetermined time delay interval; and
a.2) if said user identification datum is said time delay bypass datum, proceeding to step (b) without an intervening passage of said predetermined time delay interval.

42. A method for securely storing valuable items according to claim 39, wherein said method comprises additional steps of:
a.1) electronically determining whether entry of said user identification datum permits movement of said first enclosure towards the unlocked configuration;
a.2) if entry of said user identification datum does not permit movement of said first enclosure towards the unlocked configuration, returning to step (a); and
a.3) if entry of said user identification datum permits movement of said first enclosure towards the unlocked configuration, proceeding to step (b).

43. A method for securely storing valuable items according to claim 36, wherein said method comprises additional steps of:
a.1) electronically determining whether said first enclosure is permitted to move towards said unlocked configuration at the current time and date;
a.2) if said first enclosure is not permitted to move towards said unlocked configuration at the current time and date, electronically delaying advancement to step (b) until a permitted time and date at which said first enclosure is permitted to move towards said unlocked configuration; and
a.3) if said first enclosure is permitted to move towards said unlocked configuration at the current time and date, proceeding to step (b).
